(19) United States
(12) Patent Application Publication
(10) Pub. No.: US 2022/0106204 A1
(43) Pub. Date: Apr. 7, 2022

(54) Water Purification Cap

(71) Applicant: Microlyscs, LLC, Brooklyn, NY (US)

(72) Inventor: Rakesh Guduru, Miramar, FL (US)

(21) Appl. No.: 17/549,473

(22) Filed: Dec. 13, 2021

Related U.S. Application Data
(63) Continuation-in-part of application No. 16/745,774, filed on Jan. 17, 2020, now Pat. No. 11,225,363.
Application No. 16/745,774 is a continuation-in-part of application No. 29/705,353, filed on Sep. 11, 2019, now Pat. No. D906805.
Application No. 29/705,353 is a continuation of application No. 29/680,920, filed on Feb. 21, 2019, now Pat. No. D899926.
(60) Provisional application No. 62/828,199, filed on Apr. 2, 2019.

(51) Int. Cl. C02F 1/32; C02F 1/00

(52) U.S. Cl. CPC C02F 1/32; C02F 1/008; C02F 2209/00; C02F 2303/04; C02F 2307/02

(57) ABSTRACT

A water purification cap for covering a water bottle. The cap includes a barrel, a shell, and a waterproof compartment. The shell surrounds at least a portion of the barrel and includes a charging site that is integral to the shell. The waterproof compartment is formed within the interior of the barrel. The waterproof compartment includes one or more walls formed at least in part from quartz crystal, one or more light emitting diodes fixed within the waterproof compartment. The light emitting diodes are proximal to one end of the barrel and are oriented to shine light through the quartz crystal. The sensor is configured to determine that the cap is in the installed position and supply a voltage to a circuit configured to deliver voltage to the LEDS.

### CROSS-REFERENCE TO RELATED APPLICATION

This application is a continuation in part of U.S. patent application Ser. No. 16/745,774, filed on Jan. 17, 2020, entitled, “Water Purification Cap,” and published as U.S. Pub. No. 2020/0270034 on Aug. 27, 2020, which claims the benefit of Prov. App. No. 62/828,199 filed on Apr. 2, 2019, entitled, “Sanitization cap fro cola-style bottles” and is a Continuation in part of U.S. patent application Ser. No. 29/705,353, filed on Sep. 11, 2019, entitled, “Bottle Cap with UV LED,” and issued as U.S. Pat. No. D906,805, which is a continuation of U.S. patent application Ser. No. 29/680,920, entitled “Bottle Cap,” filed on Feb. 21, 2019, issued as U.S. Pat. No. D899,926 on Oct. 27, 2020.

### FIELD OF TECHNOLOGY

This disclosure relates to water purification. Specifically, this disclosure relates to purifying water using ultra-violet (“UV”) light.

### BACKGROUND OF THE DISCLOSURE

Microorganism-free, pathogen-free, virus-free and bacteria-free water is a necessity for human life. Many times, in various different locations around the globe, clean, bacteria-free water is unavailable because of a variety of reasons.

Traditionally, this problem has been solved by single-use plastic water bottles.

However, as a result, plastic waste from single-use plastic water bottles has grown exponentially. The plastic waste generated by disposed-of, single-use plastic water bottles has generated a waste-management problem. Additionally, single-use plastic water bottles may be costly, especially in various locations around the globe.

Therefore, it is desirable to provide an apparatus for purifying water retrieved from bio-contaminated sources or sources of unknown contamination levels.

It is further desirable for the apparatus to operate together with typical reusable bottles.

It is yet further desirable for the apparatus to operate as a cap for typical reusable bottles.

### SUMMARY OF THE DISCLOSURE

A water purification cap for covering a water bottle is provided. The water purification cap may include a barrel. The diameter of the barrel may be between 20-40 millimeters. The diameter of the barrel may be between 25-35 millimeters.

The water purification cap may include a shell. The shell may surround at least a portion of the barrel. The diameter of the shell may be between 30-50 millimeters. The diameter of the shell may be between 35-45 millimeters.

The gap between the outer diameter of the barrel and the inner diameter of the shell may be between 1 millimeter and 15 millimeters. The gap between the outer diameter of the barrel and the inner diameter of the shell may be, preferably between 3 millimeters and 10 millimeters.

The shell may include inner threads. The inner threads may enable the cap to screw onto a bottle. The bottle may be any suitable bottle, such as a reusable or non-reusable water bottle.

The water purification cap may include a charging site. The charging site may be integral to the shell—i.e., the shell may form the charging site. The charging site may charge a battery located within the cap.

It should be appreciated that the charging site may, in some embodiments, not include a charging port, or at least a readily discernable charging port. Examples of a readily discernable charging port may include a universal serial bus (“USB”) port or micro-USB port. For the purposes of this application, port-less may be understood to mean no readily discernable location for the uptake of charging power.

It should be further appreciated that even though the charging site may be port-less, the charging site may utilize a wired connection. In these embodiments, the shell itself may include at least two areas that may conduct electricity. The two areas may be constructed of metal. The first area may be a positive area. The positive area may act a positive charging pole. The second area may be a negative, or ground, area. The negative area may act as a negative charging pole. The positive area and the negative area may be in the shape of rings, or concentric circles. The positive area and the negative area may be any suitable shape. An insulation area may insulate the positive area from the negative area. The insulation area may be in the shape of a ring. The insulation area may be constructed from an insulating material, such as plastic.

A charger may be used to charge the cap. The charge may be constructed to fit over the shell of the cap. The charger may include a charging terminal. The charging terminal may be built into the inner shell of the charger. The charging terminal may include positive and negative pins. The positive pin may be operable to contact the positive area on the cap. The negative pin may be operable to contact the negative area on the cap. When the charger is fit over the shell, the positive and negative pins may come in contact with the conductive material of the shell of the cap. Once in contact with the positive and negative areas on the cap, the positive and negative pins may charge the battery within the cap. It should be appreciated that the charger may be connected, using a wired connection, or a wireless connection, to a device that provides power. Such a device may include a laptop, electric outlet or any other suitable device.

In some embodiments, other suitable methods, such as wireless charging, may be utilized.

The water purification cap may also include a waterproof compartment. The waterproof compartment may be formed within the interior of the barrel. The waterproof compartment may protect the interior components that can be damaged when exposed to water. The waterproof compartment may include at least one wall. The at least one wall may be formed at least in part from quartz crystal. Quartz crystal may be a material that enables UV-C rays to go through it. Any suitable material that allows passage of UV-C rays may be utilized to form a portion of the at least one wall. Such a material may include flexible silicon material that enables the penetration of UV-C rays.

The water purification cap may also include a light emitting diode (“LED”). The LED may be an ultra-violet C (“UV-C”) LED. A UV-C LED may be operable to produce UV-C rays. UV-C rays may include rays in the range of 100 to 280 nanometers (“nm”). UV-C rays may also include rays in the 260-280 nm range. The UV-C rays produced by the LED may preferably be about 278 nm.

It should be appreciated that, the UV-C rays may be produced, by the LED, without the use of toxic mercury. Toxic mercury may be harmful if ingested.

UV-C rays may penetrate liquids. UV-C rays may penetrate translucent, or partially-translucent liquids. UV-C rays may penetrate microbial cells included in liquids and/or translucent liquids. UV-C rays may destroy the active core (nucleic acids) of the microbial cells. The microbial cells may no longer be viable without the active core. After a period of time, the non-active microbial cells may revert to fundamental constituents, such as carbon dioxide (CO2), and trace elements, such as N (Nitrogen), P (Phosphorus), O (Oxygen) and S (Sulfur).

In some embodiments, the cap may include a safety feature to prevent damage from UV-C rays. The safety feature may guard an unprotected eye or skin which may be damaged by UV-C rays. The safety feature may restrict the UV-C LED from being activated unless the cap is secured onto a bottle. The safety feature may include one, two or more pins included in an inner portion of the shell. The one, two or more pins may restrict the UV-C LED from activating unless the pins are depressed. The pins may not be depressed when the cap is detached from a bottle. The pins may be depressed when the cap is screwed onto, or otherwise in secured to a bottle.

The LED may be fixed within the waterproof compartment. The LED may be proximal to one end of the barrel. The LED may be oriented to shine light through the quartz crystal.

The cap may include a sensor. The sensor, when activated, may apply a voltage to the LED. Applying a voltage to the LED may cause the LED to emit light, such as UV-C light. The sensor may be a touch sensor. The sensor may be a button. The sensor may be any other suitable sensor.

In some embodiments, the barrel and/or any other component of the cap may be constructed from stainless steel.

In some embodiments, the barrel may be, in whole, or in part, constructed from plastic. When the UV-C rays are emitted from the LED, micro-cracks may form in the portion of the barrel that is exposed to the light. Therefore, a shield, which may be constructed from a metallic material, such as stainless-steel, may protect the portion of the barrel from being exposed to the UV-C rays. In this way, the barrel is not exposed to, and possibly damaged by, the UV-C rays.

As such, the cap may include a shield. The shield may be stainless-steel. The shield may be constructed from any suitable metallic material. The shield may be constructed from any other suitable material. The shield may be operable to shield the barrel from light generated by the LED.

Additionally, the construction of the cap may be a pressure-fit construction—i.e., the components within the cap may be pressure-fit to one another. For example, the shield may be pressure-fit to the barrel and the barrel may be pressure-fit to the shell. The pressure-fitting may be important because the construction may preferably not include glue. Glue may be undesirable because glue may degrade, and as the glue degrades, it may leach into the water included in the bottle.

In some embodiments, the shell and/or the barrel may include a digital display. The digital display may display data. The data may include the status of the UV-C LED—i.e., whether the UV-C LED is on, or how much battery power is left. The data may also include the status of the liquid in the bottle—i.e., whether the water has been sanitized. The data may also include the status of the charge of the battery included in the cap.

The cap may also include one or more gaskets. The one or more gaskets may be constructed from silicon or any other suitable material. The one or more gaskets may surround a portion of the barrel that is near the UV-C LED. The one or more gaskets may seal a bottle to which the water purification cap is secured. The one or more gaskets may provide a 360-degree seal, or complete seal of the contents of the bottle.

In some embodiments, the cap may include a total dissolved solids (“TDS”) sensor. The TDS sensor may record the total dissolved solids of the contents of the bottle. The digital display may display the total dissolved solids.

The cap may also include a temperature probe. The temperature probe may record the temperature of the contents of the bottle. The digital display may display the recorded temperature. The digital display may also indicate a phase state indicator—e.g., the indicator may indicate the percentage of water and/or ice that is currently in the bottle.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative perspective top-down view of embodiments of the disclosure;

FIG. 2 shows an illustrative perspective bottom-up view of embodiments of the disclosure;

FIGS. 3A and 3B shows an illustrative cross-sectional view of embodiments of the disclosure;

FIG. 4 shows an illustrative top view of embodiments of the disclosure;

FIG. 5 shows an illustrative bottom view of embodiments of the disclosure;

FIG. 6 shows an illustrative perspective view of embodiments of the disclosure;

FIG. 7 shows an illustrative top view of embodiments of the disclosure;

FIG. 8 shows an illustrative bottom view of embodiments of the disclosure;

FIG. 9 shows an illustrative prospective view of embodiments of the disclosure;

FIG. 10 shows an illustrative top view of embodiments of the disclosure;

FIG. 11 shows an illustrative exploded view of embodiments of the disclosure;

FIG. 12 shows another illustrative exploded view of embodiments of the disclosure;

FIG. 13 shows another illustrative side view of embodiments of the disclosure;

FIG. 14 shows another illustrative perspective view of embodiments of the disclosure;

FIG. 15 shows another illustrative perspective view of embodiments of the disclosure;

FIG. 16 shows another illustrative perspective view of embodiments of the disclosure;

FIG. 17 shows another illustrative bottom view of embodiments of the disclosure; and

FIG. 18 shows another illustrative bottom view of embodiments of the disclosure.

### DETAILED DESCRIPTION OF THE DISCLOSURE

A water purification cap for covering a water bottle is provided. The cap may include a barrel. The cap may include a shell. The shell may surround a first end of the barrel.

The cap may include charging site. The charging site may be integral to the shell. The charging site may include a positive area, a negative (or ground) area and an insulation ring. The insulation ring may insulate between the positive area and the negative area.

The cap may include a UV-C LED. The UV-C LED may be proximal to the second end of the barrel. The UV-C LED may be oriented to shine light from the second end of the barrel. The light emitted from the LED may be ultraviolet light ranging between 100 and 400 nm. UV-C light may be short-wave UV rays in the range of 100-280 nanometers. In some embodiments, the light emitted from the UV-C LED may preferably be about 278 nm.

The cap may include a sensor. The sensor may be operable to activate the UV-C LED. The sensor may be a touch sensor. The sensor may be a button. The sensor may be any suitable sensor.

In some embodiments, the touch sensor may respond to a single touch, double touch or multi-touch. A single touch may initiate the display of the remaining battery charge. The insulation ring, as will be described below, may show the remaining battery charge. Such an insulation ring may be illuminated in different colors according to the level of charge remaining. Such an insulation ring may be illuminated by a ring shaped, or other, red green blue (“RGB”) LED.

A double touch may initiate activation of the UV-C LED for a first predetermined period of time. The first predetermined period of time may be 30 seconds, 60 seconds, 90 seconds or any other suitable period of time. Exposure of the contents of the bottle to the UV-C LED rays for the first predetermined period of time may be suitable for destroying microbial cells found in liquids from mildly to moderately contaminated sources. Such mildly to moderately contaminated sources may include unfiltered tap water and water from fountains. Exposure of a UV-C LED to a 6-128-ounce bottle for the first predetermined time period may sterilize the contents of the bottle to 99.99%.

A multi-touch, such as a three, four, five, six or other suitable amount of touches may initiate activation of the UV-C LED for a second predetermined period of time. The second predetermined time period may be 90 seconds, 120 second, 150 seconds, 240 seconds, 360 seconds or any other suitable time period. Exposure of the contents of the bottle to the UV-C LED rays for the second predetermined period of time may be suitable for destroying microbial cells found in liquids from moderately to highly contaminated sources. Such moderately to highly contaminated sources may include water from lakes and ponds. Exposure of a UV-C LED to a 6-128-ounce bottle for the second predetermined time period may sterilize the contents of the bottle to 99.9999%.

In some embodiments, the insulation ring may be a red green blue (“RGB”) ring. The RGB ring may illuminate in order to indicate a status of the cap. The RGB ring may illuminate various colors. Each of the colors may indicate a different status of the cap. In addition to the color of the illumination, the frequency of the illumination—e.g., whether the illumination is constant, quick-blinking or slow-blinking—may indicate various status levels of the cap.

For example, slow-blinking blue illumination may indicate that sterilization is in progress. Upon sterilization completion, a solid-green illumination may be shown.

Also, indication of 50%-100% of remaining battery charge may be displayed using a solid-green illumination. Indication of 25%-50% of remaining battery charge may be displayed using a solid-orange illumination. Indication of 0%-25% of remaining battery charge may be displayed using a solid-red illumination.

It should be appreciated that any suitable color display for any suitable status may be contemplated within the scope of the disclosure.

It should also be appreciated that the water purification cap may be used to sanitize or disinfect multiple surfaces, such as keyboards, laptops, computers, mice, jewelry, toothbrushes or any other suitable surfaces.

Apparatus described herein are illustrative. Apparatus in accordance with this disclosure will now be described in connection with the figures, which form a part hereof. The figures show illustrative features of apparatus in accordance with the principles of this disclosure. It is to be understood that other embodiments may be utilized and that structural, functional and procedural modifications may be made without departing from the scope and spirit of the present disclosure.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

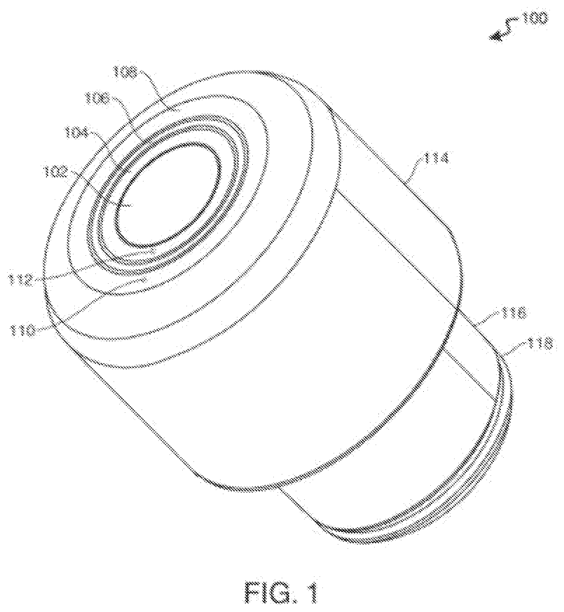

FIG. 1 shows a top-down perspective view of water purification cap 100. Water purification cap 100 may include shell 114 and barrel 116. A portion of barrel 116 may be covered by shell 114.

Water purification cap 100 may be constructed from metallic materials, glass materials, quartz crystal materials, silicon materials, plastic materials, any other suitable materials or a combination thereof. Most preferably, shell 114 may be constructed at least partially from stainless steel, and barrel 116 may be constructed at least partially from plastic.

Water purification cap 100 may include a charging site. The charging site may be integrated into shell 114. Pole 104 may be an area located on shell 114 that is configured to conduct electricity. Pole 104 may be constructed from a metallic, such as metal or stainless steel. Pole 104 may act as positive charging pole, or vice versa.

Pole 108 may be an area located on shell 114 that is configured to conduct electricity. Pole 108 may be constructed from a metallic, such as metal or stainless steel. Pole 108 may act as a negative charging pole, or vice versa.

Pole 104 and pole 108 may be opposite charging poles. As such, one pole may be negative and a second pole may be positive. The positive pole and the negative pole may be insulated from each other. Red green blue (“RGB”) ring 106 may insulate between pole 104 and pole 108. RGB ring may separate the negative pole from the positive pole.

Exemplary contact point 112 may be an exemplary point on pole 104 that may come in contact with a charger, which will be described in further detail below. Exemplary contact point 110 may be an exemplary point on pole 108 that may come in contact with a charger, which will be described in further detail below. It should be appreciated that the contact points are exemplary, and that the charging pins, included in the charger, may come in contact with any location on pole 104 or pole 108.

RGB ring 106 may insulate between pole 104 and pole 108. RGB ring 106 may also illuminate various colors. RGB ring 106 may illuminate colors based on a status of the cap. Such a status may include ON status of the UV-C LED, battery charge status or any other suitable status, or combination of status levels.

Water purification cap 100 may also include sensor 102. Sensor 102 may be a touch sensor. The touch sensor may be sensitive to touch. The touch sensor may activate the UV-C LED or the illumination of the RGB ring in response to one or more taps.

Water purification cap 100 may also include gasket 118. Gasket 118 may be constructed from silicon or any other suitable material. Gasket 118 may seal a bottle to which the water purification cap is secured. Gasket 118 may provide a 360-degree seal, or complete seal of the contents of the bottle.

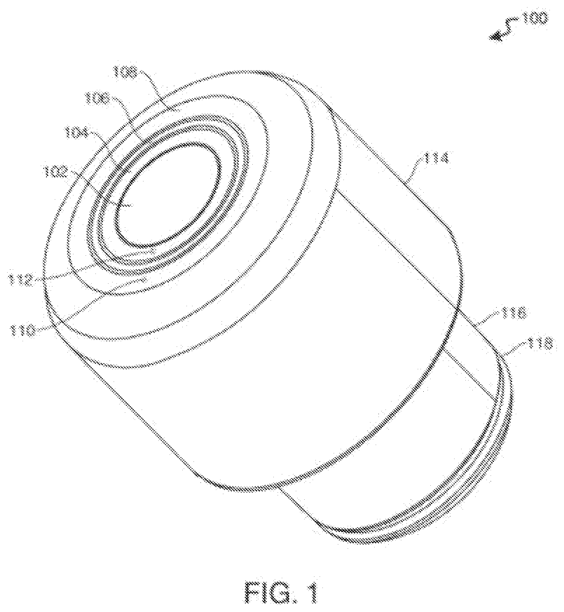

FIG. 2 shows an illustrative perspective bottom-up view of water purification cap 100. As shown, an inner portion of shell 114 may include inner threads 202. Inner threads 202 may enable water purification cap 100 to screw onto a conventional reusable water bottle.

UV-C LED 204 may be operable to shine UV-C LED rays when activated. UV-C LED 204 may be included in an inner, waterproof compartment of barrel 116. Quartz crystal 206 may maintain the waterproof properties of the inner compartment of barrel 116. Quartz crystal 206 may enable the UV-C LED rays to shine out from the compartment into a bottle (not shown).

Barrel 116 may include lower end of barrel 210. Lower end of barrel 210 may be near gasket 118. Lower end of barrel 210 may be primarily constructed from plastic material. It should be appreciated that rays from UV-C LED 204 may create micro-cracks in lower end of barrel 210. As such, shield 208, which may be constructed from a suitable metallic, such as stainless steel, or other suitable material, may protect lower end of barrel 210 from exposure to the rays from UV-C LED 204.

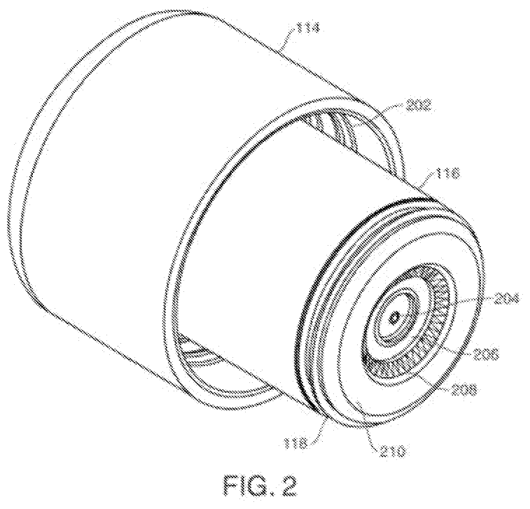

FIGS. 3A and 3B shows an illustrative cross-section of water purification cap 100. FIG. 3A shows the cross-section line. FIG. 3B shows the cross-sectional view.

The cross-sectional view shows touch sensor 102 activating internal components of water purification cap 100 using spring 302.

Quartz crystal 206 may be surrounded by silicon o-ring 308. Silicon o-ring 308 may ensure a pressure-fit and watertight-ness of quartz crystal 206 and other components included in the cap.

Shield 208 may be formed from one or more pieces (see FIG. 3B which shows shield 208 in two pieces).

UV-C LED 204 (not shown in the cross-section) may be mounted onto PCB-A 306. PCB-A 306 may be a printed circuit board assembly. PCB-A may stand for printed circuit board assembly. A PCB may be a printed circuit board that mechanically supports and electrically connects electrical or electronic components using conductive tracks, pads and other features etched from one or more sheet layers of copper laminated onto and/or between sheet layers of a nonconductive substrate.

Battery 304 may power one or more components included in cap 100. Such components may include PCB-A board 306.

Padding, or thermal insulation, may be included in between battery 304 and PCB-A board 306. UV-C LED 204 may generate heat. Therefore, PCB-A board 306 may become hot. As such, padding, or thermal insulation may protect battery 304 from being damaged by heat generated by UV-C LED 204. The padding, or thermal insulation may be constructed from Styrofoam™ or any other suitable insulating material.

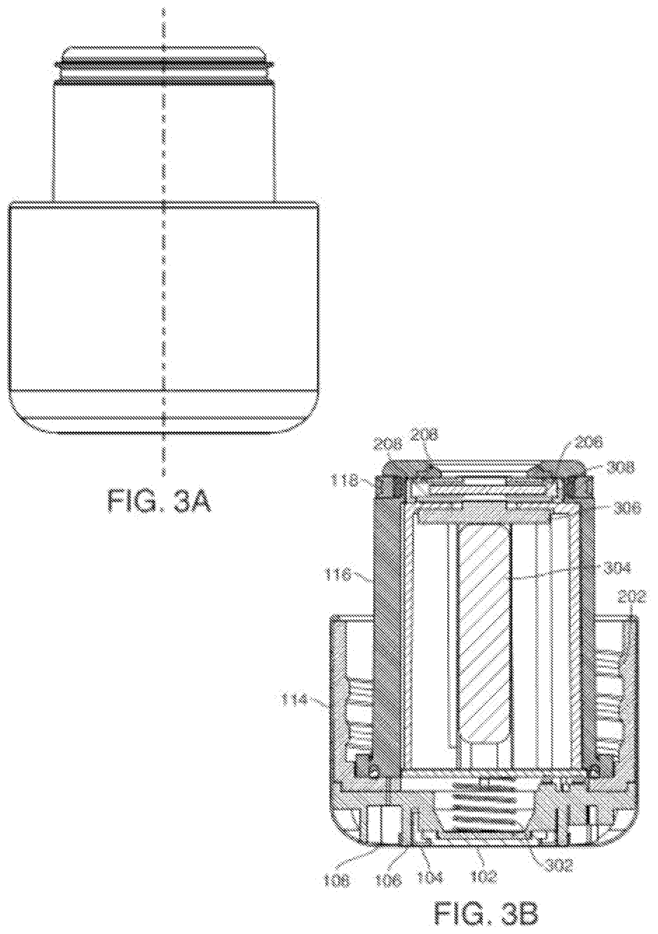

FIG. 4 shows an illustrative top view of water purification cap 100.

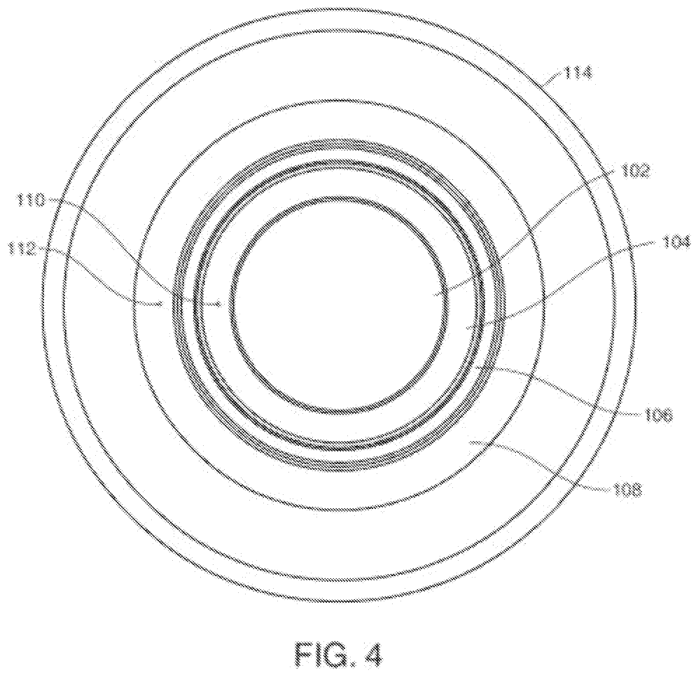

FIG. 5 shows an illustrative bottom view of water purification cap 100.

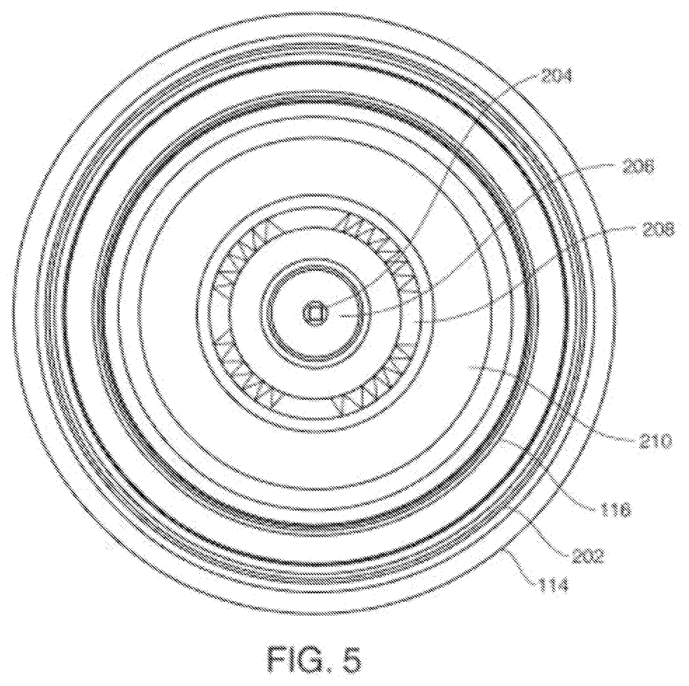

FIG. 6 shows an illustrative perspective view of charging cover 600. Charging cover 600 may be operable to fit over shell 114 of water purification cap 100.

Charging cover 600 may include U-shaped hole 602. U-shaped hole 602 may enable a user to view RGB ring 106. RGB ring 106 may illuminate an orange color during the charging process. RGB ring 106 may illuminate a green color when the charging process has been completed. As such, U-shaped hole 602 may preferably enable the user to determine the status of the charge without removing water purification cap 100 from charging cover 600.

Charging cover 600 may also include connection 606. Connection 606 may connect cover 600 to connection port 604. Connection port 604 may be a USB port, micro-USB port or any other suitable port. Connection port 604 may connect to a computer, outlet or any other suitable device that provides electric power.

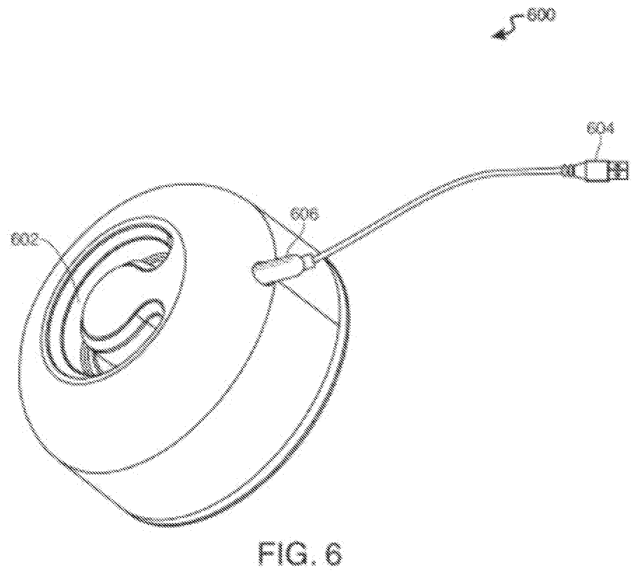

FIG. 7 shows an illustrative top view of cover 600. It should be appreciated that connection 606 may connect cover 600 to any suitable connection port, such as connection port 604.

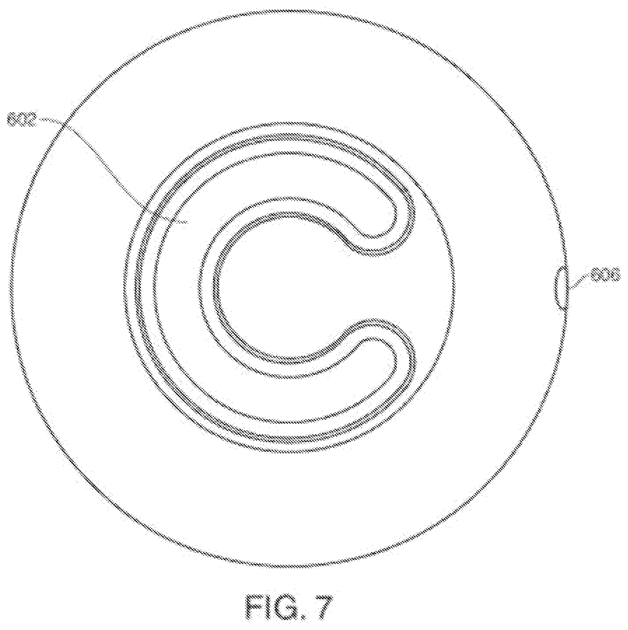

FIG. 8 shows an illustrative bottom view of cover 600. Bottom view of cover 600 shows charging pins 802 and 804. Charging pins 802 and 804 may be preferably flexible and at least partially depress-able. Charging pin 802 may connect to pole 104 on cap 100. Charging pin 804 may connect to pole 108 on cap 100. It should be appreciated that charging pins 802 and 804 may retract into cover 600, or retract into themselves, when depressed. This depression enables cover 600 to effectively cover shell 114 when charging.

It should be appreciated that cover 600 may include an inner portion and an outer portion. The inner portion may snap into the outer portion using snap 806.

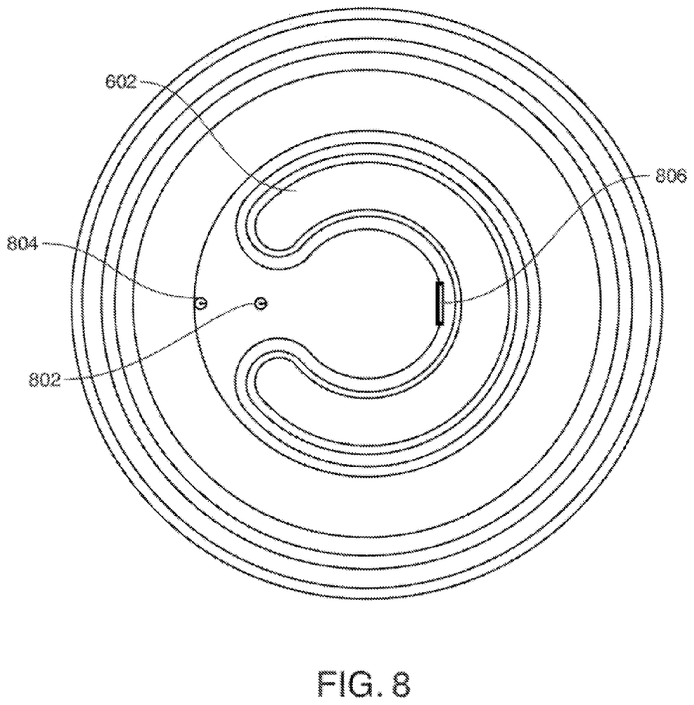

FIG. 9 shows an illustrative perspective view of cover 600 covering shell 114.

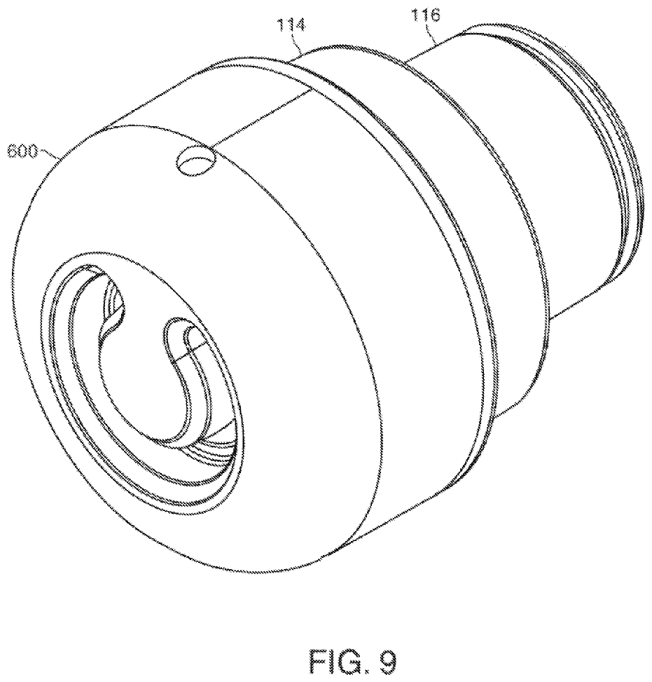

FIG. 10 shows an illustrative top view of cover 600 covering shell 114. Through U-shaped hole 602, a portion of pole 104, a portion of pole 108 and RGB ring 106 may be visible.

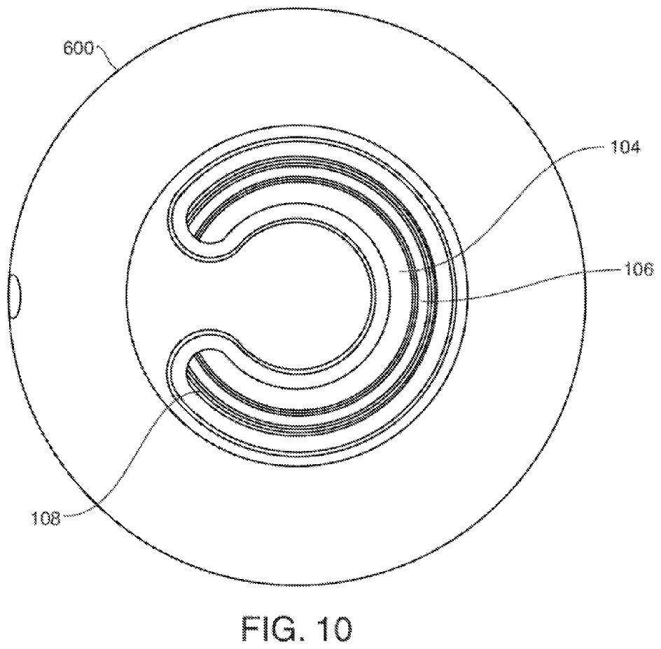

FIG. 11 shows an exploded view of water purification cap 100. The components shown in water purification cap include shell 114. Touch sensor 102, which may be a touch pad, may be included in shell 114. Ring 1102 may be a charging ring. In some embodiments, ring 1102 may be constructed from metallic material. Ring 1102 may be a positive or negative charging area. Ring 1102 may preferably be a positive charging area.

Shell 114 may be constructed from metallic material. As such, shell 114 may be conductive. Therefore, a portion of shell 114 that is external to RGB ring 106 may be utilized as a positive or negative charging area. The portion of shell 114 that is external to RGB ring 106 may be, preferably, a negative charging area.

RGB ring 106 may be a casing that creates an isolation between positive and negative areas, such as ring 1102 and shell 114.

Charging pin 1104 may be a charging pin internal to shell 114. Charging pin 1104 may be a positive or negative charging pin. Charging pin 1104 may be preferably a negative charging pin. Charging pin 1104 may form a ground connection with PCB board 1108. Charging pin 1104 may contact outer portion of shell 114. Charging pin 1104 may give negative contact to outer portion of shell 114.

Charging pin 1106 may be a charging pin internal to shell 114. Charging pin 1106 may be a positive or negative charging pin. Charging pin 1106 may be preferably a positive charging pin. Charging pin 1106 may have a positive connection with PCB board 1108.

Spring 302 may be mounted to PCB board 1108. A second LED (not shown) may be mounted onto PCB board 1108. The second LED may be an RGB LED. The RGB LED may illuminate RGB ring 106. Therefore, the top of RGB ring 106 may show the color and/or illumination of RGB LED mounted onto PCB board 1108.

Inner portion of shell 1310 may include inner threads 202. Inner threads 202 may enable cap 100 to screw onto a bottle, such as a reusable water bottle.

Battery 304 may connect, using wires (not shown), to PCB board 1108. Battery 304 may also connect, using wires (not shown) to PCB-A board 306. UV-C LED 204 (not shown) may be mounted on PCB-A board 306. O-ring 1114 may surround PCB-A board 306. O-ring 1114 may be constructed from silicon material. O-ring 1114 may enable the pressure-fit of cap 100. O-ring 1114 may also enable the watertight-ness of the internal components of cap 100.

Internal compartment 1116 may fit into barrel 116. O-ring 308 may surround quartz crystal 206. Shield 208 may protect lower end of barrel 210 from exposure to the UV-C rays.

Casing for barrel 1118 may form a portion of barrel 116. Gasket 118 may surround a lower portion of casing for barrel 1118. Gasket 118 may be constructed from silicon or any other suitable material.

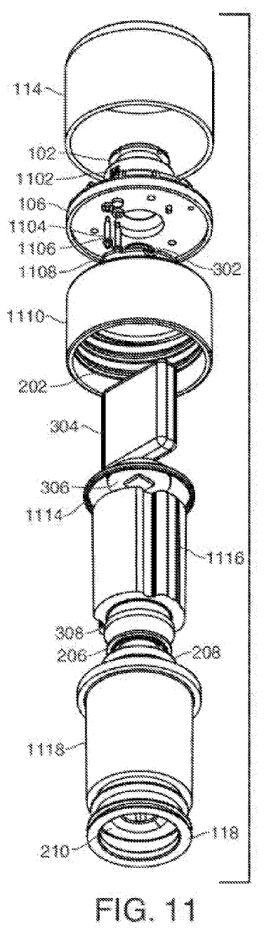

FIG. 12 shows another exploded view of water purification cap 100.

It should be appreciated that these components may be pressure-fit to one another. As discussed above, it may be preferable for the construction to be glue-less.

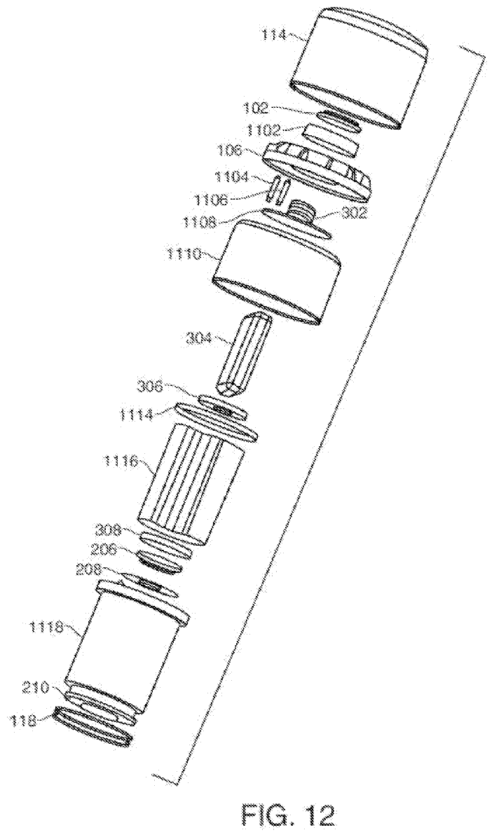

FIG. 13 shows a front view of a purification assembly 1200 comprising a purification cap 1210 including a handle 1208 having a strap 1206 and pair of studs 1204. Purification cap 1210 is removably fastened to a bottle 1220. Purification cap 1210 is similar in structure and function to purification cap 100 except as otherwise described below. The cap 1210 may include a fixed, or a moveable handle 1208. The handle 1208 may be fixedly coupled or rotatably coupled to a top surface, a side surface, or a surface most proximal to bottle 1220. The handle 1080 may be removeable or fixed to the cap after being assembled at a manufacturing facility.

Cap 1210 further includes a sensor positioned within cap 1210 and configured to determine whether the cap 1210 is in an installed position or an uninstalled position. More specifically the sensor is positioned in or on the shell 1212 or barrel (not shown) of the cap 1210 but may be positioned in any position so that the sensor may determine that the cap 1210 is in an installed position as shown in FIG. 13. Cap further includes a bottle facing surface 1214 positioned most proximate to a cap facing surface 1222 of the bottle 1020 in the installed position. Cap further includes a power supply such as battery 304 (See FIG. 11) and a wiring circuit (not shown). The power supply is in electrical communication with the sensor via the wiring circuit, and the sensor is in electrical communication with the UV-C LEDS 604 (See FIGS. 6 and 25-26). Sensor includes a circuit breaker (not shown) and an activation button 1032,1332. The circuit breaker is in electrical communication with the power supply via the wiring circuit and the circuit breaker is in electrical communication with the activation button 1032.

The activation button 1032 is in electrical communication with the UV-C LEDS 604 via the wiring circuit. In the installed position, the sensor allows the circuit breaker to supply voltage to the activation button 1032. Once the activation button 1032 is supplied voltage, a user may then depress activation button 1032 with a thumb or finger or otherwise enable activation button 1032 to supply voltage to the one or more UV-C LEDS 604 to illuminate the UV-C LEDS 604. In the uninstalled position, the circuit breaker disallows electrical communication between the power supply and the activation button 1032. When in the uninstalled position, depressing the activation button 1032 does not supply power to the UV-C LEDS 604. In some versions the sensor can include a time delay that momentarily bridges electrical communication between the power supply and the activation button so that voltage may be supplied via the time delay for a 5 second time period in the uninstalled position. The 5 second time period is not meant to be unnecessarily limiting, but merely an exemplary time period that allows a user to inspect the UV-C LEDS 604 operation, but prevents prolonged exposure of the user to UV-C LED light. In some versions, the activation button 1032 is a component separate and apart from the sensor.

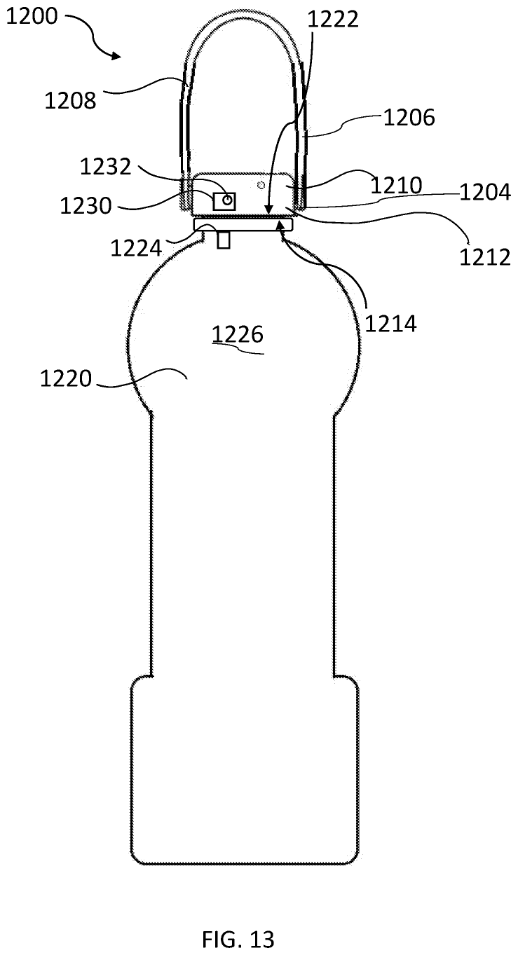

The sensor may include a contact sensor 1330 (see FIG. 14) or a noncontact sensor 1230. In versions including noncontact sensors 1220, the bottle facing surface 1214 of the cap 1210 may not need to touch the cap facing surface 1222 of the bottle 1220 to indicate that the cap 1210 is in the installed position. The noncontact sensor 1230 uses a perceived capacitive change, impedance change, or resistive change to activate or deactivate the supply voltage to the activation button 1032 via the circuit breaker. The noncontact sensor 1220 may further include an impedance sensor, Hall effect sensor, an aluminum-detecting sensor, all metal sensors, a pulse-response sensors and/or other proximity sensors known in the art that determine a first body is proximate to a second body without the first body contacting the second body.

One type of non-contact sensor may include the impedance sensor. The impedance sensor which senses physical property of the material could be metallic or non-metallic portion of the bottle 1220 that introduces a change in the impedance do the capacitive coupling. The metallic portion of the bottle 1220 may include a metallic housing 1226 or a metallic ring (not shown) positioned proximal to the cap facing surface 1222. Predetermined values of impedance for the installed position and the uninstalled position are stored within a memory (not shown) of the impedance sensor. In some versions, the memory may be positioned within a processor (not shown) separate from the impedance sensor. The impedance sensor determines measured values of impedance and compares the measured values with the predetermined values of impedance. In the installed position the impedance sensor activates the supply voltage to the activation button 1032 and in the uninstalled position deactivates the supply voltage to the activation button 1032. Aluminum-detecting sensors and all-metal sensors operate similarly to the impedance sensor by comparing the measured impedance value with a predetermined value that represents the installed position and the uninstalled position. When the measured impedance corresponds with the predetermined value that represents the installed position the circuit breaker supplies voltage to the activation button 1032 and deactivates the supply of voltage to the activation button 1032 when the measured impedance corresponds with the uninstalled position.

The Hall effect sensor detects a sensed element such as a magnet 1224 or a magnetic portion of the bottle 1220. The magnetic portion of the bottle 1220 having magnetic properties may include the housing 1226 or a metallic ring (not shown) having magnetic properties. When the Hall effect sensor becomes proximate to the magnet 1224 or housing 1226, the Hall effect sensor converts magnetically encoded information into an electrical signal when in the installed position and uninstalled position to respectively activate and deactivate the supply voltage to the activation button 1032. The Hall effect sensor is capable of activating or deactivating the supply voltage when positioned 10 millimeters or less from the magnetic portion of the bottle or the magnet.

FIG. 14 shows an illustrative top-down perspective view of illustrative purification cap 1300. Cap 1300 is similar to cap 200 described above except as otherwise noted below. Cap 1300 is configured to be removably coupled to bottle 1220. Cap 1300 is fitted with a pivotable handle 1310 rotatably coupled to a side surface 1320 of the cap 1300. The pivotable handle 1310 including a top beam 1312, a pair of side beams 1314, and a pair of studs 1316. The handle is configured so that the cap 1300 and bottle 1220 may be carried by a person using a hand to grip the top beam 1312. Top beam 1312 extends transverse to the longitudinal axis of the cap and operatively attaches to the pair of side beams 1314. Side beams 1314 are rotatably coupled to a pair of studs 1316 extending from a side surface 1320 of the cap 1300. Studs 1316 may be affixed to the cap with a fastener (not shown) or may be integrally formed with the shell 1122. Side beams 1314 are configured to rotate about the studs 1316. The top beam 1312 may be curved in some versions and may directly couple to the studs 1316.

Cap 1300 also differs from cap 1200 in that cap 1300 includes the contact sensor 1330 rather than the noncontact sensor 1230 of cap 1200. Contact sensor 1330 includes one or more pins (see FIG. 11) that are included in an inner portion of the shell. When the one or more pins contact the cap facing portion 1222 the pin retracts within or towards a body of contact sensor and closes the circuit breaker that provide power to the activation button 1032. Once power is supplied to the activation button 1032, the activation button may be depressed to provide power to the UV-C LEDS 604 via wiring circuit. It should be noted that contact sensors do not require or need the bottle 1220 to include specific properties or any additional components and may be used with a reusable or non-reusable bottle.

In other versions, the contact sensor 1330 may also include a resistance sensor is located proximate to the bottle facing surface 1214 of the cap 1210 and the resistance sensor engages the cap facing surface 1222 or a portion of the threads (not shown) of the bottle 1220 and determines an installed resistance in an installed position is less than an uninstalled resistance in an uninstalled position (see FIG. 14). For example, in the uninstalled position the uninstalled resistance may be an extremely high value such as an infinite resistance and in the installed position the value will be some value much less than the infinite resistance based on the material properties of the bottle 1220. When a lesser resistance is detected, the resistance sensor allows the circuit breaker to supply power to the activation button 1032.

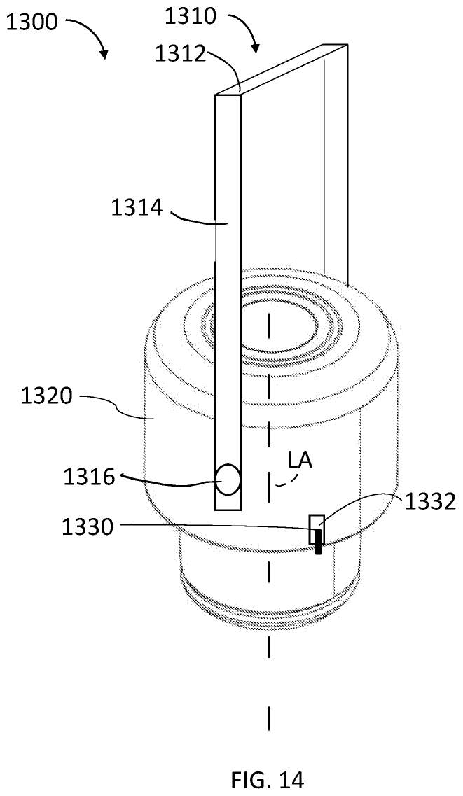

FIG. 15 shows an illustrative top-down perspective view of illustrative purification cap 1400 with an integrally formed handle 1410 attached with a pair of side beams 1414 to a side surface 1420 of the cap 1400. Integrally formed handle 1410 may be formed of the same material as the shell 1422 and extend distally along longitudinal axis LA to a top beam 1412.

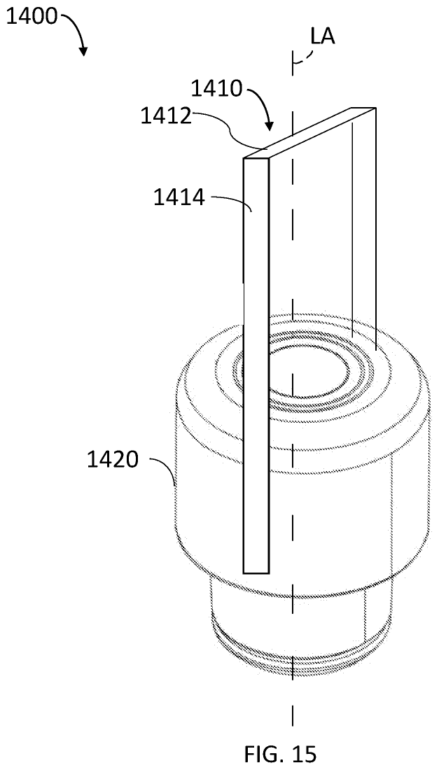

FIG. 16 shows an illustrative top-down perspective view of illustrative purification cap 1600 with an integrally formed handle 1510 to a top surface 1530 of the cap 1500. Integrally formed handle 1510 may be formed of the same material as the shell 1522 and extend distally along longitudinal axis LA and curve from a first side of the top surface 1530 to a second side of the top surface 1530.

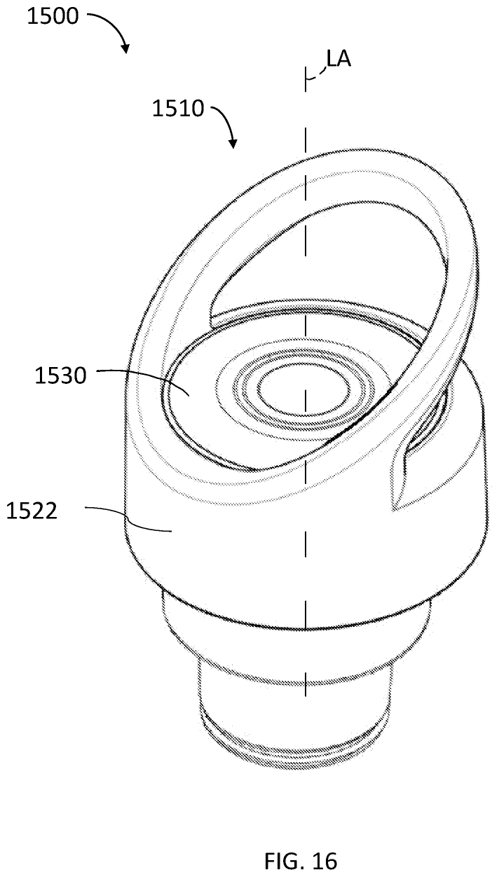

FIG. 17 shows an illustrative bottom-up plan view of illustrative purification cap 1900. Cap 1600 is similar in structure and function to cap 100 except as otherwise described below. Cap 1600 differs from cap 100 in that cap 1600 includes a pair of UV-C LEDS 204 rather than one UV-C LED 204. The pair of UV-C LEDS 204 when activated may be used to shine UV-C rays into a liquid contained within the bottle 1220. The UV-C rays may be used to sterilize the liquid within the bottle 1220. Using more than one UV-C LEDS 204 reduces the thermal load on the UV-C LEDS 204 and provides the same radiant flux output as a single UV-C LED 204, but the pair of UV-C LEDS 204 are configured to be operated at a reduced radiant flux output which create less heat rise thereby exponentially reducing the failure rate of the UV-LEDS 204. Additionally, using more than one UV-LED 204 minimizes the effects of proximately located microscopic contaminants to a single UV-LED 204 from blocking distally located microscopic contaminants from receiving light from the UV-LED 204. In some versions, the UV-LEDS 204 are spaced apart by a spacing 1610 of at least 1 mm. In other versions, the UV-LEDS 204 are spaced apart by a spacing 1610 of at least 5 mm. In yet other versions, the UV-LEDS 204 are spaced apart by a spacing 1610 of at least 7 mm. Stated differently, the spacing 1610 provides alternate paths for the light emitted from the UV-LEDS 204 to reach the distally located microscopic contaminants.

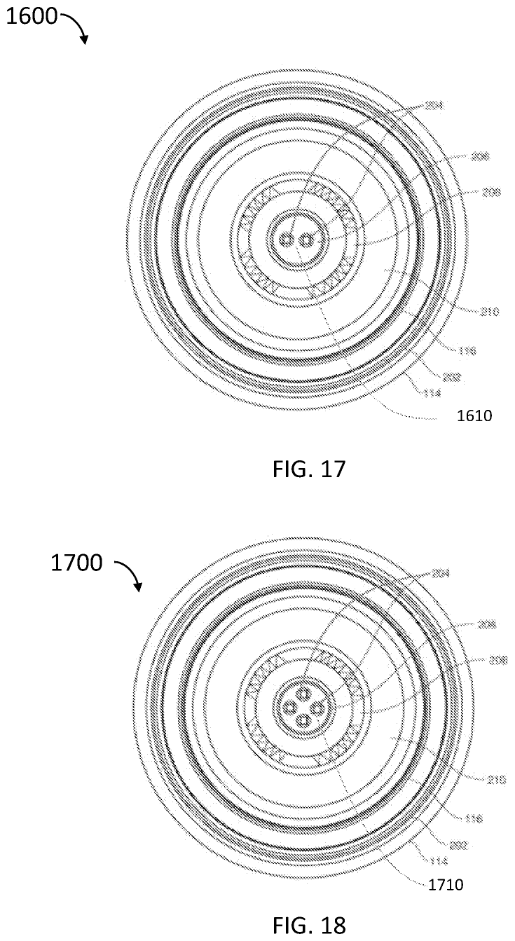

FIG. 18 shows an illustrative bottom-up view of illustrative purification cap 1700. The cap 1700 is similar in structure and function to the cap 1600 except as otherwise described below. The cap 1700 differs from the cap 1600 in that the cap 1700 includes a plurality of UV-C LEDS 204. The plurality of UV-C LEDS 204 maintains the same radiant flux output as the pair UV-C LEDS 204 of the cap 1600 and further reduces the failure rate of the plurality of UV-LEDS 204. The present example shows five UV-C LEDS 204 but any number of UV-C LEDS 204 that are sufficient to sterilize the contents of the bottle 1220 and further reduce the failure rate of the UV-LEDS 204 may be utilized. Additionally, having multiple sources of UV-LEDS 204 separated by at least 5 mm can improve the effect of sterilization by minimizing the shadow effect caused by the microscopic contaminants (less than 10 micrometer in size) i.e., if microscopic contaminants pose a shadow by blocking the UV-C LED light rays coming from one UV-C LEDS, having a secondary light source placed at least 5 mm apart will minimize such a shadow effect and improve sterilization efficacy. In some versions, each of the plurality of UV-LEDS 204 are spaced apart by a spacing 1710 of at least 1 mm from an adjacent UV-LED 204. In other versions, the UV-LEDS 204 are spaced apart by a spacing 1710 of at least 5 mm. In yet other versions, the UV-LEDS 204 are spaced apart by a spacing 1710 of at least 7 mm. Stated differently, the spacing 1710 between the plurality of UV-LEDS 204 provides additional alternate paths for the light to be emitted from the plurality of UV-LEDS 204 to reach the distally located microscopic contaminants.

### MISCELLANEOUS

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A water purification cap for covering a water bottle, comprising:
(a) a barrel;
(b) a shell surrounding at least a portion of the barrel, wherein the shell includes a charging site integral to the shell; and
(c) a waterproof compartment formed within an interior of the barrel, comprising:
(i) one wall formed at least in part from quartz crystal,
(ii) one or more light emitting diodes (“LEDS”) fixed within the waterproof compartment and proximal to one end of the barrel, and oriented to shine light through the quartz crystal, and
(iii) a sensor configured to determine that the cap is in an installed position and supply a voltage to a circuit configured to deliver voltage to the LEDS.

2. The water purification cap of claim 1, wherein the LEDS include ultraviolet light LEDS (“UV-LEDS”).

3. The water purification cap of claim 2, wherein the UV-LEDS are configured to pass light through a liquid adjacent to a bottom portion of the water purification cap to sterilize the liquid.

4. The water purification cap of claim 3, wherein each of the UV-LEDS are spaced apart from an adjacent UV-LED by at least 5 mm to minimize a proximate microscopic contaminant from blocking a UV light from reaching a distal microscopic contaminant thereby increasing an efficacy of sterilization.

5. The water purification cap of claim 3, wherein each of the UV-LEDS are spaced apart from an adjacent UV-LED by at least 1 mm to minimize a proximate microscopic contaminant from blocking a UV light from reaching a distal microscopic contaminant thereby increasing an efficacy of sterilization.

6. The water purification cap of claim 3, wherein each of the UV-LEDS are spaced apart from an adjacent UV-LED by at least 7 mm to minimize a proximate microscopic contaminant from blocking a UV light from reaching a distal microscopic contaminant thereby increasing an efficacy of sterilization.

7. The water purification cap of claim 1, wherein the waterproof compartment includes a stainless-steel shield operable to shield the barrel from light generated by the LEDS.

8. The water purification cap of claim 1, wherein the sensor includes a circuit breaker and an activation button, wherein the circuit breaker is configured to supply the voltage to the activation button when the sensor determines that the cap is in the installed position, and wherein the sensor determines that the cap is in an uninstalled position disallows voltage to be supplied to the activation button.

9. The water purification cap of claim 8, wherein the activation button is configured to supply voltage to the LEDS when the activation button is enabled.

10. The water purification cap of claim 1, wherein the sensor includes a contact sensor.

11. The water purification cap of claim 10, wherein the contact sensor includes a resistance sensor configured to engage a metallic portion of a bottle and determines a measured resistance when the cap is in an installed position, wherein the measured resistance is compared with a predetermined value of resistance that corresponds with the installed position, wherein the resistance sensor in the installed position allows voltage to pass through a portion of the sensor.

12. The water purification cap of claim 11, wherein the contact sensor further includes an activation button configured to be supplied voltage from the resistance sensor in the installed position, wherein in the installed position the activation button may be actuated by a user to supply voltage to the LEDS.

13. The water purification cap of claim 10, wherein the contact sensor includes one or more pins configured to engage a portion of the water bottle when the cap is in the installed position and transition the pins from an open position to a closed position, wherein the open position the pins are incapable of allowing voltage to pass through the pins, and in the closed position the pins allow voltage to pass through a portion of the sensor.

14. The water purification cap of claim 1, wherein the sensor includes a non-contact sensor.

15. The water purification cap of claim 14, wherein the non-contact sensor determines the cap is in the installed position by being in close proximity to a sensed element.

16. A water purification cap for removable coupling to a water bottle, comprising:
(a) a barrel;
(b) a shell that surrounds a first end of the barrel;
(c) a handle configured to carry the cap and bottle when the cap is coupled to the bottle;
(d) one or more UV-C (“ultra-violet C”) light emitting diodes (“LEDS”), wherein the LEDS are proximal to a second end of the barrel; and oriented to shine light from the second end of the barrel; and
(e) a sensor configured to activate the UV-C LEDS when the cap is in an installed position.

17. The water purification cap of claim 16, further comprising a charging site integral to the shell.

18. The water purification cap of claim 16, wherein the sensor includes an activation switch, wherein the activation switch is activated by a user in the installed position to supply a voltage to the UV-C LEDS.

19. A water purification cap, comprising:
(a) a barrel;
(b) a shell positioned around the barrel;
(c) a handle extending from a first end of the cap, wherein the handle is configured to be carried by a user;
(d) one or more UV-C (“ultra-violet C”) light emitting diodes (“LEDS”), wherein the LEDS are positioned on a second end opposite the first end, wherein the LEDS are configured to sterilize a body; and
(e) a non-contact sensor configured to determine the cap is proximate to a sensed element and allows voltage to be delivered to the LEDS.

20. The water purification cap of claim 19, wherein the non-contact sensor includes an activation button, wherein the activation button prevents the voltage from being delivered to the LEDS without interaction from the user.
